(19) United States
(12) Patent Application Publication
(10) Pub. No.: US 2016/0183603 A1
(43) Pub. Date: Jun. 30, 2016

(54) CHILD PROTECTION SYSTEM AND CONTROL FUNCTIONALITY

(71) Applicant: Not Your Child Corp., Brampton (CA)

(72) Inventor: Julia Matthews, Waterloo (CA)

(21) Appl. No.: 14/982,903

(22) Filed: Dec. 29, 2015

Related U.S. Application Data
(60) Provisional application No. 62/097,344, filed on Dec. 29, 2014.
(60) Provisional application No. 62/150,349, filed on Apr. 21, 2015.

(51) Int. Cl. A41D 1/00; A41B 11/00; A41D 20/00; A41B 1/08; G01S 1/04; A41D 27/20; G01S 19/16; G01S 19/47; G01S 19/42; H04W 4/02; A41D 1/06

(52) U.S. Cl. CPC A41D 1/002; H04W 4/023; A41B 11/006; A41D 20/00; A41B 1/08; A41D 1/06; A41D 27/205; G01S 19/16; G01S 19/47; G01S 19/42; G01S 1/042

(57) ABSTRACT

A system having garments and locating devices. Each of the garments includes at least one hidden pocket, and each of the locating devices is adapted to be disposed in one of the hidden pockets. The locating device may be a GPS or a GPS/IPS device. The system may also have adapters, and each of the adapters defines a pocket adapted to receive the locating device. The adapters also have a surface adapted to be heat-sealed to fabrics.

### CROSS-REFERENCE TO RELATED APPLICATIONS

This application claims priority to U.S. Provisional Patent Application Ser. No. 62/097,344, filed Dec. 29, 2014, and U.S. Provisional Patent Application Ser. No. 62/150,349, filed Apr. 21, 2015, each of which is incorporated herein by reference in its entirety.

### BACKGROUND OF THE INVENTION

1. Field of the Invention

The invention relates to the field of personal security.

2. Description of the Related Art

It is known to track a child through a GPS transmitter.

### SUMMARY OF THE INVENTION

Forming one aspect of the invention is a system comprising: garments, each having at least one hidden pocket; and locating devices, each adapted to be disposed in one of the hidden pockets.

Forming another aspect of the invention is a system comprising: locating devices; and adapters, each adapter defining a pocket adapted to receive a locating device and having a surface adapted to be heat-sealed to fabrics.

Other advantages and features will become apparent upon review of the following description and the accompanying drawings, the latter being briefly described hereinafter.

### BRIEF DESCRIPTION OF THE DRAWINGS

FIG. 1 is a view of the components of a system according to an exemplary embodiment of the invention disclosed herein;

FIG. 2 is an enlarged view of encircled area 2 of FIG. 1; and

FIG. 3 is a view of the components of a system according to a further exemplary embodiment of the invention.

### DETAILED DESCRIPTION OF THE INVENTION

The embodiments discussed herein are merely illustrative of specific manners in which to make and use the invention and are not to be interpreted as limiting the scope.

While the invention has been described with a certain degree of particularity, it is to be noted that many modifications may be made in the details of the invention's construction and the arrangement of its components without departing from the scope of this disclosure. It is understood that the invention is not limited to the embodiments set forth herein for purposes of exemplification.

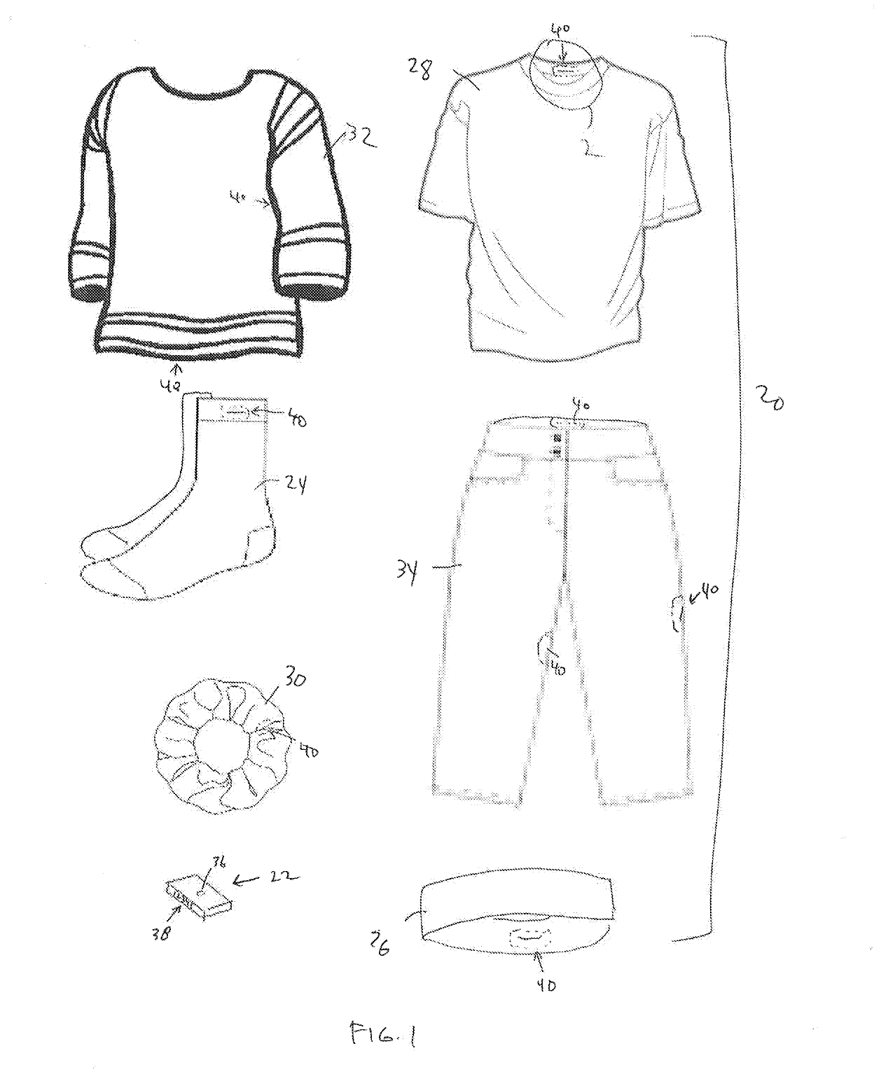

Reference is made to FIG. 1 which shows the components of a system 20 according to an exemplary embodiment of the invention, which system 20 includes locating devices 22 and garments 24, 26, 28, 30, 32 and 34.

Each locating device 20 is: a GPS locating device; water-proof; about 45-55 mm×35-38 mm×10-12 mm in size; rechargeable; configurable, via a switch 36, between an active mode and an inactive mode; marked with a unique code 38; configurable, when in the active mode, in a standby mode, wherein the device is capable of receiving a trigger signal; configurable, when in the active mode, in an alert mode, wherein the device is functional to allow for location of the device and allow for remote monitoring of battery life; capable of transmitting, when in the alert mode, for 48 hours on a full charge; adapted, when in the standby mode and upon receipt of the trigger, to assume the alert mode; and at least partially flexible, by virtue of a flexible FPC lithium-ceramic battery (not shown).

Each garment 24, 26, 28, 30, 32 and 34 has at least one hidden pocket 40.

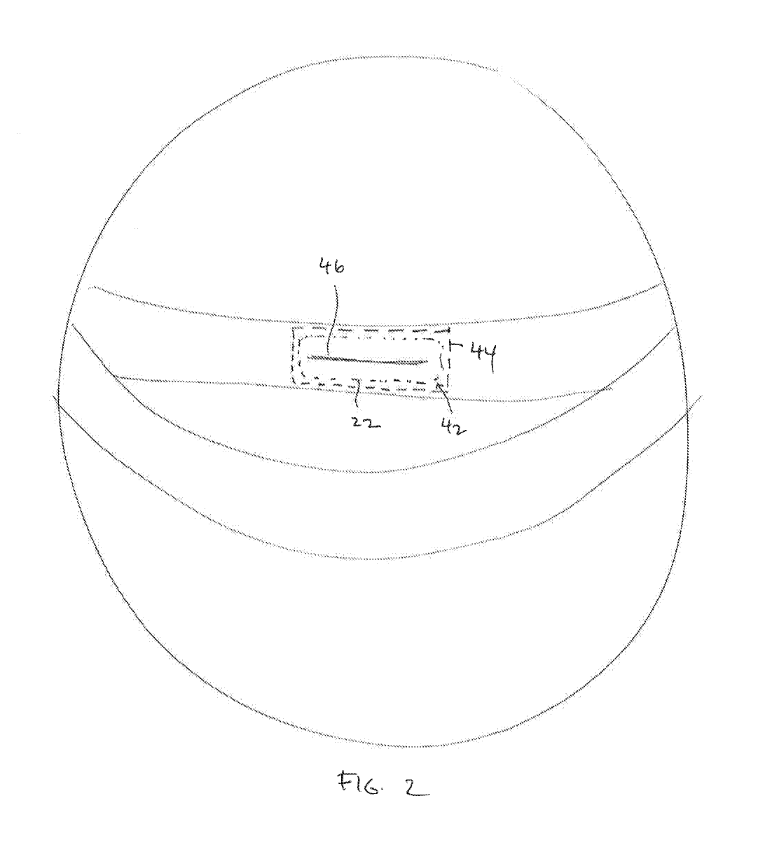

As seen in FIG. 2, each hidden pocket 40 is defined by a pair of layers of fabric secured to one another to define a cavity 42 having a perimeter 44 defined by the conjoined fabric. The cavity is adapted to receive one of the locating devices in substantially-space-filling relation such that, when the locating device is received by the cavity, as shown, the layers of fabric are spaced apart from one another by about 2.5 mm; a slit 46 is defined in the one of the layers, the slit substantially bisecting that portion of the one layer surrounded by the perimeter.

The garments include pairs of sockettes 24, headbands 26, t-shirts 28, hair scrunchies 30, long sleeve shirts 32 and pairs of pants 34.

In respect of the pairs of sockettes 24, one of the pairs has the hidden pocket 40 defined in a cuff thereof.

In respect of the headbands 26, the hidden pocket 40 is defined in the backside thereof

In respect of the t-shirts 28, the hidden pocket 40 is defined under the collar of the t-shirt.

In respect of the hair scrunchies 30, the hidden pockets 40 are defined interiorly thereof.

In respect of the long sleeve shirts 32, the at least one hidden pocket 40 is defined by a hidden pocket 40 defined in an arm seam, a hidden pocket 40 in a waist seam and a hidden pocket 40 in a lower hem.

In respect of the pairs of pants 34, the at least one hidden pocket in each pair of pants is defined by a hidden pocket 40 defined in a waist inseam, a hidden pocket 40 defined in an inseam and a hidden pocket 40 defined near the knee.

For use, the devices 22 and garments 24, 26, 28, 30, 32 and 34 are sold to parents.

Access to a control functionality can be made available, via a website or a downloadable app. One known service is that commercially available at www.positionlogic.com.

Using this functionality, parents may access the control functionality and create a secure user account.

Upon receipt of a device, the parent can access the control functionality and dedicate the device to a user account via entry of the unique code.

The account to which a device is dedicated may assign the device to other user accounts or rededicate the device to a different account.

Any account holder to which a device is dedicated can, in respect of each of such dedicated device that is in the active configuration, cause the device to assume either of the standby and alert modes.

Any account holder to which a device is dedicated or assigned can, in respect of each of such dedicated or assigned devices, cause the device to assume the alert mode and monitor the location and battery life of any assigned or dedicated devices in the alert mode.

Parents can thereby enhance the security of their children by clothing them in the garments and placing a charged device in the garment each day when the child leaves, for example, for school. In the event that a child becomes lost, the locating device will enable the parent to identify the location of the child. In the event that a child is abducted, the locating device serves the same purpose.

As the device can be placed in any one of a number of hidden pockets, the likelihood of the locating device coming to the attention of a kidnapper and being removed is relatively low.

Some or all of the clothing of the child may be marked with indicia visible to potential kidnappers that signifies that the child may be wearing a locating device. Although that notice indeed might cause some kidnappers to conduct clothing searches for locating devices that might otherwise not have been done, some parents may perceive the deterrent value of such warning as being sufficiently large as to overcome this drawback.

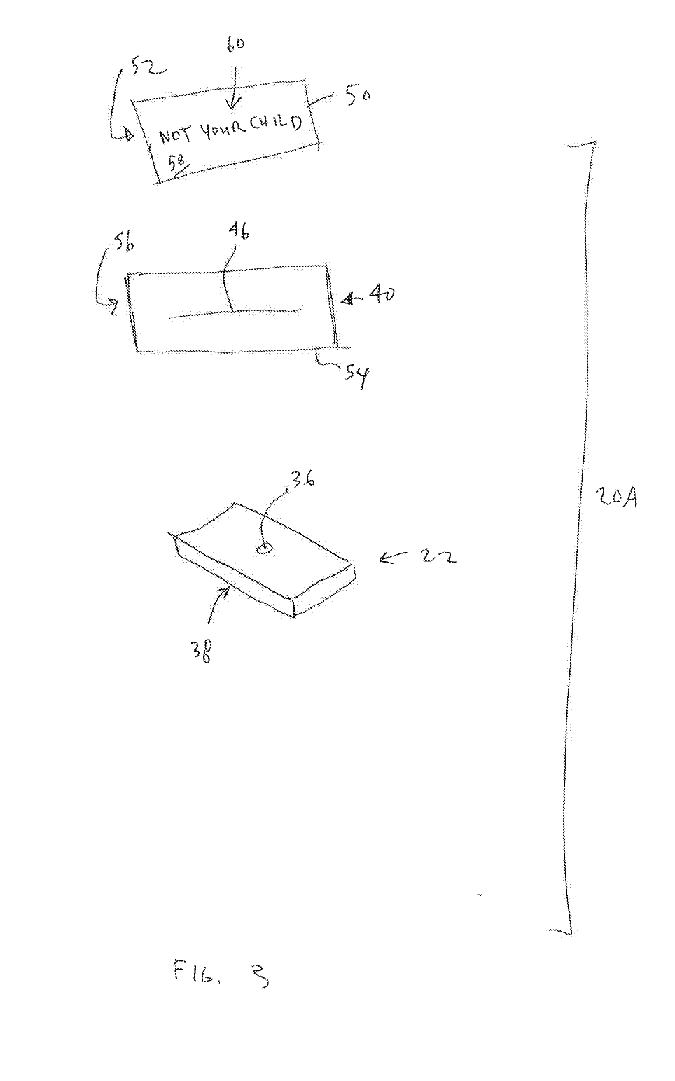

The components of a system 20A according to an alternate embodiment of the invention are shown in FIG. 3 and will be seen to include the locating devices 22, patches 50 and adapters 54, each adapter defining a pocket 40 adapted to receive a locating device and having a surface 56 adapted to be heat sealed to fabrics. p It will be evident to persons of ordinary skill that the combination of adapters 54 and locating devices 22 enable, inter alia, parents to replicate much of the functionality of the earlier-described embodiment with conventional articles of clothing; rather than being forced to purchase clothing with hidden pockets formed therein, the parent can simply heat seal adapters interiorly of the articles of clothing in the wardrobe of the child to provide the hidden pockets. The alternative system can also include patches 50 that have a surface 52 adapted to be heat sealed to fabrics and a surface 58 bearing indicia 60 visible to potential kidnappers that signifies that the child may be wearing a locating device, all for the same reasons as indicated above.

Whereas two specific embodiment are herein described, variations are possible.

For example, algorithms can be provided to generate automatically send a trigger to a device at a specified time, for example, at the end of a school day, such that minimal battery charge is expended during the day and only at the end of the school day when the child is expected to be walking home from school and risks are heightened does the device transmit location.

Algorithms can also be provided to create geographic zones and times, to send a warning if a child leaves a zone otherwise than as scheduled.

As well, whereas specific sizes, shapes, and positions are disclosed, it will be apparent that these can be changed.

Further, whereas a specific commercially available tracking functionality is mentioned, other computing functionalities can be utilized.

Further, whereas GPS is specifically mentioned for locating purposes, other tracking methodologies, such as IPS, GPRS and GSM can usefully be used.

As well, specific mention is made of the sale of the systems to parents, the systems can also be sold to sports teams, schools and the like, that have an interest in the safe custody of the children in their temporary charge.

Accordingly, the invention should be understood to be limited only by the accompanying claims, purposively construed.

Whereas, the invention has been described in relation to the drawings attached hereto, it should be understood that other and further modifications, apart from those shown or suggested herein, may be made within the scope of this invention.

What is claimed is:

1. A system comprising:
garments, each having at least one hidden pocket; and
locating devices, each adapted to be disposed in one of the hidden pockets.

2. A system according to claim 1, wherein the locating device is a GPS device.

3. A system according to claim 1, wherein the locating device is a GPS/IPS device.

4. A system comprising:
locating devices; and
adapters, each adapter defining a pocket adapted to receive a locating device and having a surface adapted to be heat-sealed to fabrics.

5. A system according to claim 1, wherein the locating device is a GPS device.

6. A system according to claim 1, wherein the locating device is a GPS/IPS device.
